(19) United States
(12) Patent Application Publication
(10) Pub. No.: US 2012/0022709 A1
(43) Pub. Date: Jan. 26, 2012

(54) ENERGY DELIVERY CONTROL SYSTEMS AND METHODS

(76) Inventor: Steven M. Taylor, Indianapolis, IN (US)

(21) Appl. No.: 13/147,528

(22) PCT Filed: Feb. 2, 2010
(86) PCT No.: PCT/US2010/022878

§ 371 Date: Oct. 11, 2011

Related U.S. Application Data
(60) Provisional application No. 61/206,580, filed on Feb. 2, 2009.

(51) Int. Cl. G06F 1/32

(52) U.S. Cl. 700/295

(57) ABSTRACT

An electrical load control management system (10) associated with an appliance (24) includes at least one of a load control device (16) and a programmable thermostat (18) configured to selectively reduce power supplied to the appliance (24) in response to a demand response event. An optional opt-out control (120, 124, and 69) is associated with at least one of the load control device (16) and programmable thermostat (18). The opt-out control (120, 124, and 69) is actuatable to permit a consumer to opt-out of a demand response event.

### BACKGROUND AND SUMMARY

The present invention relates to various methods and apparatus for controlling energy delivery from a utility to a plurality of consumers at remote locations. More particularly, the present invention relates to improved load control devices, programmable thermostat devices and corresponding demand response energy delivery control systems and methods.

As energy utilities cope with increasing energy demand and increasing costs for purchasing energy such as electricity, the popularity of a utility-sponsored demand response programs has increased. Such demand response programs typically use programmable thermostats and/or load control devices to control appliances at a customer location. Specifically, the utility may selectively shut off certain appliances or reduce the power drawn by such appliances during peak power demand times. Utilities typically implement demand response programs when energy consumption peaks which strains the electric grid, resulting in higher prices for both utilities and customers.

Programmable thermostats and/or load control devices used in homes or businesses provides the utility the ability to cycle equipment or appliances such as air conditioners on and off for short periods of time. Utilities can also change temperature settings using the programmable thermostats at different times to control energy use. By controlling peak energy use, utilities can reduce the need for additional power plants, reduce the likelihood of brown-outs or black-outs, and reduce prices. In return for participating in the demand response programs, consumers typically receive a credit on their monthly utility bill.

The system and method of the present invention facilitates control of programmable thermostats and/or load control devices by both utilities and by consumers. The devices facilitate letting the consumer occasionally opt-out from the demand response program when such cycling on and off an appliance would be inconvenient. The present system and method also provides improved monitoring techniques for data collection and analysis. Such data collection may also be used with control algorithms for controlling the demand response system.

In one illustrated embodiment of the present disclosure, an electrical load control management system associated with an appliance comprises a load control device configured to selectively reduce power supplied to the appliance in response to a demand response event, and an externally accessible opt-out control associated with the load control device. The opt-out control is actuatable to permit a consumer to opt-out of a demand response event.

In one illustrated embodiment, the opt-out control is located on the load control device. In another illustrated embodiment, the opt-out control is located on an opt-out device separate from the load control device.

In another illustrated embodiment of the present disclosure, an electrical load control management system associated with an appliance comprises a programmable thermostat configured to selectively reduce power supplied to the appliance in response to a demand response event, and an opt-out control associated with the programmable thermostat. The opt-out control is actuatable to permit a consumer to opt-out of a demand response event.

In one illustrated embodiment, the opt-out control is located on the programmable thermostat. In another illustrated embodiment, the opt-out control is accessible via a graphical user interface separate from the programmable thermostat.

In yet another illustrated embodiment of the present disclosure, an electrical load control management system comprises a load control device configured to selectively reduce the power supplied to an appliance in response to a demand response event received from a utility's computer at a remote location. The load control device is configured to measure line voltage and current supplied to the appliance at predetermined time intervals. The load control device is also configured to calculate power from the measured line voltage and current values before and after the demand response event to determine a direct load shed measurement corresponding to the demand response event.

In one illustrated embodiment, the load control device stores the measured line voltage and current taken at the predetermined time intervals in a memory of the load control device and transmits the stored line voltage and current values to a utility's computer located at a remote location. In another illustrated embodiment, the load control device monitors the line voltage supplied to the appliance. The load control device is configured to automatically shut off power to the appliance if the monitored line voltage drops below a predetermined threshold level to reduce the likelihood of a brownout.

Additional features and advantages of the present invention will become apparent to those skilled in the art upon consideration of the following detailed description of illustrative embodiments exemplifying the best mode of carrying out the invention as presently perceived.

### BRIEF DESCRIPTION OF THE DRAWINGS

The detailed description particularly refers to the accompanying figures in which:

FIG. 1 is a block diagram of an energy delivery control system;

FIG. 2 is a block diagram of an illustrated demand response control system for a programmable thermostat or a load control device;

FIG. 3 is a block diagram illustrating details of a demand response thermostat;

FIG. 4 is an exemplary thermostat display illustrating settings and conditions for a selected thermostat;

FIGS. 5-8 illustrate sample display screens which permit a consumer to control a programmable thermostat from a remote location through a graphic user interface;

FIG. 9 illustrates a display screen for an administrative program diagnostic tool;

FIG. 10 illustrates a control interface screen for a dispatch program which sends instructions to load control devices and programmable thermostats;

FIG. 11 is a block diagram illustrating details of an exemplary load control device;

FIG. 12 is an illustrative graph showing voltage, current and frequency measured by a load control device;

FIG. 13 is an illustrated display screen shown when a diagnostic user checks the status of a particular load control device using a diagnostic tool;

FIGS. 14-19 illustrate embodiments of an opt-out device which permits a consumer to opt out of a particular demand response event; and

FIG. 20 illustrates circuitry configured to detect if a consumer has bypassed a load control device.

### DETAILED DESCRIPTION OF THE DRAWINGS

For the purposes of promoting an understanding of the principles of the invention, reference will now be made to certain illustrated embodiments and specific language will be used to describe the same. No limitation of the scope of the claims is thereby intended. Such alterations and further modifications of the invention, and such further applications of the principles of the invention as described herein as would normally occur to one skilled in the art to which the invention pertains, are contemplated, and desired to be protected.

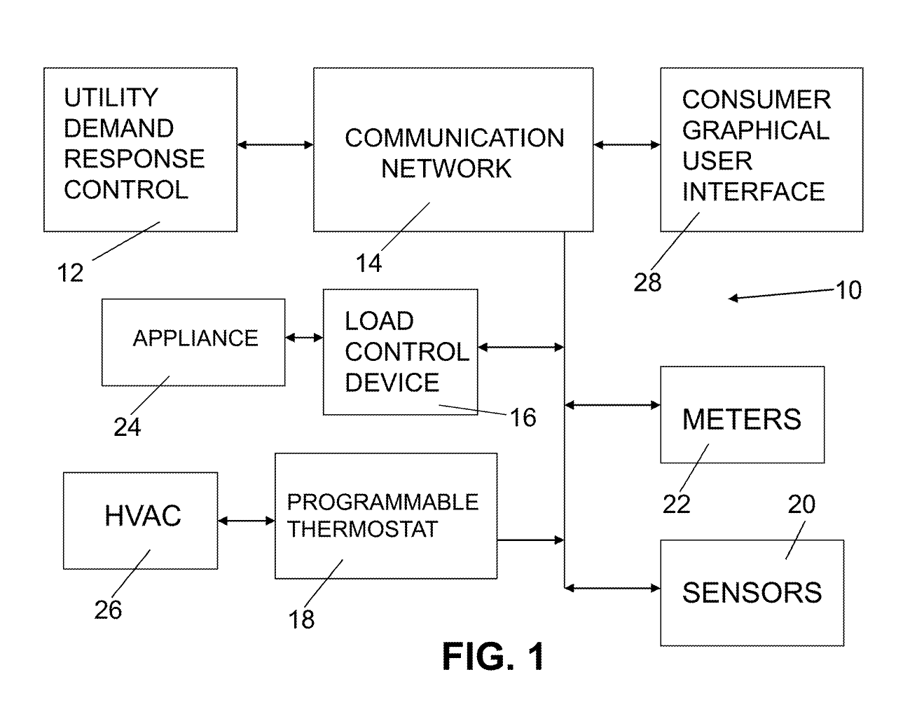

Referring now to the drawings, FIG. 1 is a block diagram of an energy delivery control system 10 of the present disclosure. As discussed in detail below, a demand response utility control system 12 is provided. The utility control system 12 typically includes hardware and software to perform administrative functions and dispatch programs for controlling the demand response energy delivery as discussed below. The utility control system 12 communicates through a communication network 14 to a plurality of load control devices 16, a plurality of programmable thermostats 18, a plurality of sensors 20, and a plurality of meters 22. Any conventional communication network 14 may be used. The load control devices 16 are illustratively load control receivers (LCRs).

The load control devices 16 may control various appliances 24 such as air conditioning units, heaters, furnaces, refrigerators/freezers, water heaters, dishwashers, pool pumps, or any other desired appliance. The sensors 20 may include indoor temperature sensors, outdoor temperature sensors, humidity sensors, or other desired sensors. The programmable thermostat 18 is illustratively coupled to an HVAC system 26 including air conditioning units and heaters or furnaces.

The utility control system 12 communicates with the load control devices 16, the programmable thermostat 18, the sensors 20, and meters 22 through communication network 14 to selectively turn appliances 24 and HVAC system components 26 on and off during peak demand times for energy. The system 10 further includes a consumer graphical user interface 28 which permits consumers to control the load control devices 16 and programmable thermostats 18 using a computer coupled to the communication network 14. Therefore, the consumers may control the load control devices 16 and programmable thermostats 18 and monitor operation of the system through a computer coupled to the communication network 14 from any location including a remote location from a building where the load control device 16 and programmable thermostat 18 are located.

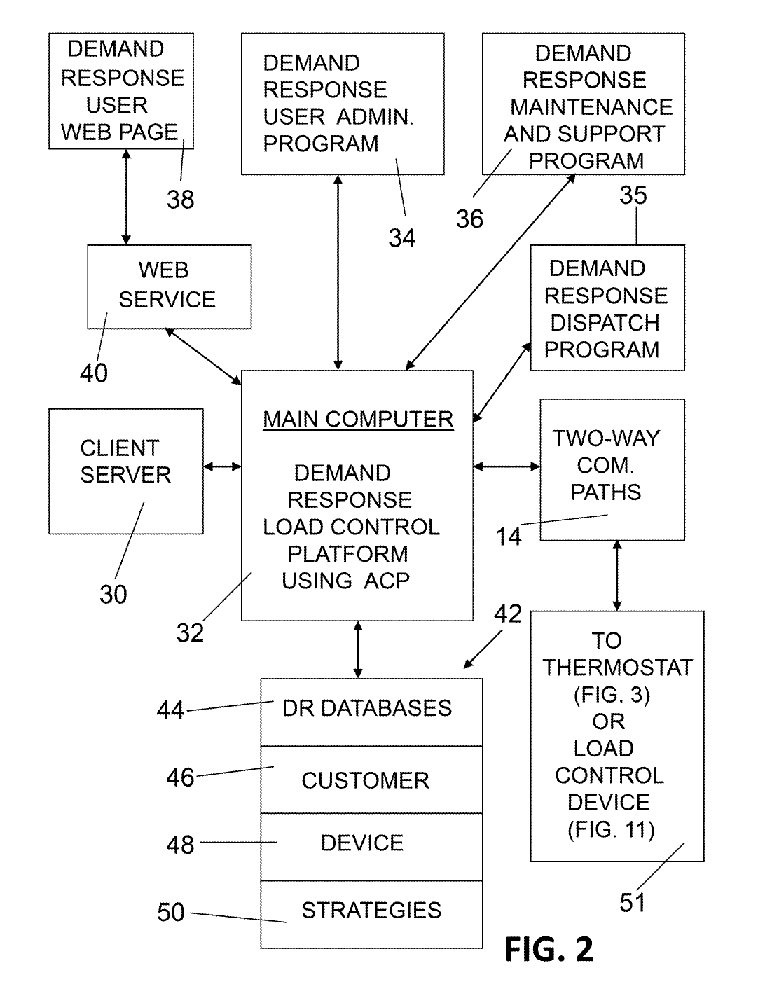

FIG. 2 is a block diagram of an illustrated control system for a demand response programmable thermostat 18 or a load control device 16. As illustrated in FIG. 2, a client server 30 communicates through a main computer 32 illustratively running a suitable demand response load control platform. An exemplary load control platform is a Two-Way Demand Response (DR) Protocol available from Corporate Systems Engineering, LLC (CSE) located in Indianapolis, Ind. Main computer 32 communicates with a demand response system administrator program 34, a demand response dispatch program 35, a demand response maintenance and support program 36, and a demand response user web page 38 through a web service 40. Main computer 32 includes a memory 42 for storing a plurality of demand response databases 44 including a customer database 46, a device database 48, and a strategy database 50.

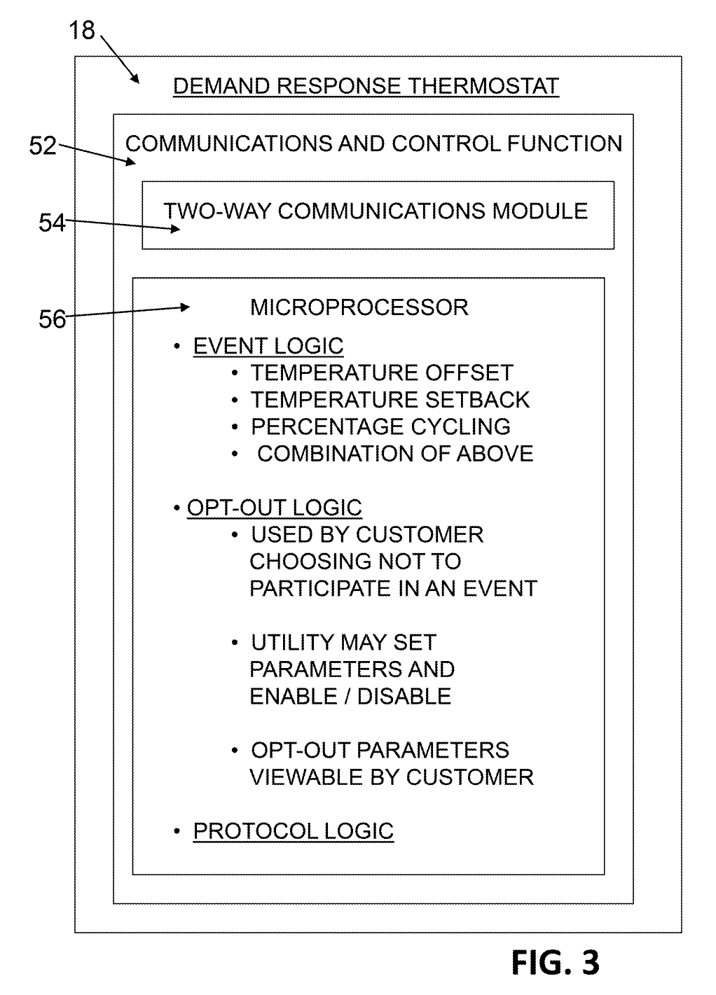

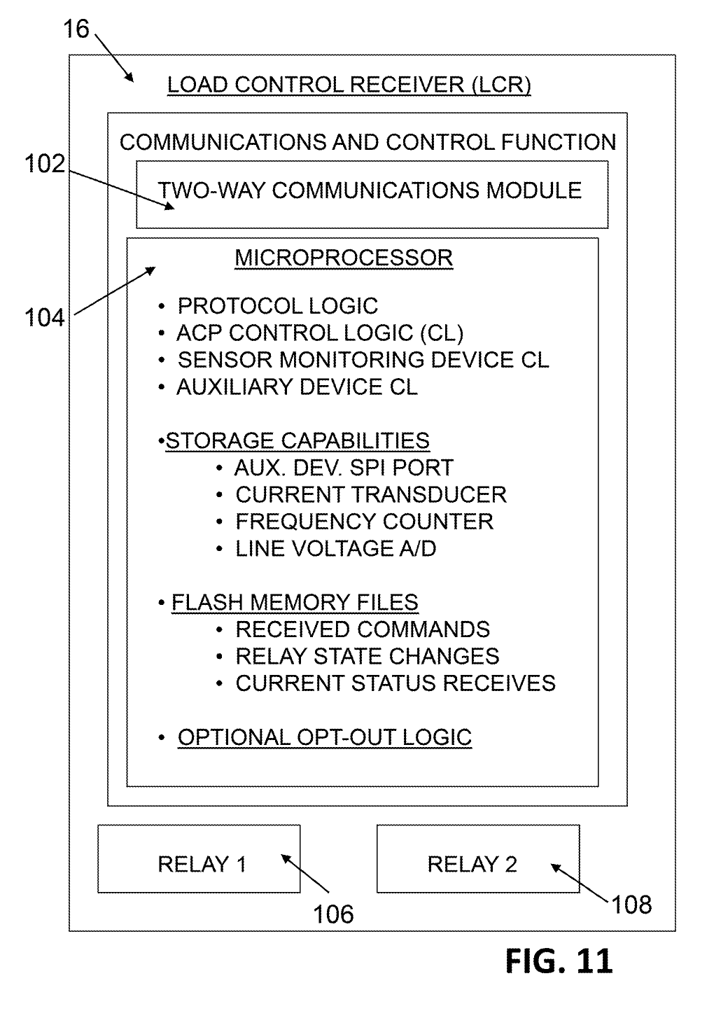

As discussed above, main computer 32 communicates through a two-way communication network 14 with a programmable thermostat 18 as shown in FIG. 3 or a load control receiver 16 shown in FIG. 11 as illustrated at block 51 of FIG. 2. Illustratively, a communications and control function 52 of thermostat 18 includes a two-way communication module 54 and a microprocessor 56 configured to permit communication with the thermostat 18 as shown in FIG. 3. The microprocessor 56 is programmed with logic to respond to certain demand response event commands sent from the main computer 32 in response to administrator and dispatch programs 34 and 36. The microprocessor 56 is programmed with event logic to provide a temperature offset, a temperature setback, a percentage cycling, or combination of these features. In addition, an optional opt-out feature may be available for use by the consumer if they choose not to participate in a particular demand response event. The utility may put parameters around the availability of logic that will prevent or enable the customer to opt-out. The opt-out parameters are illustratively viewable to the consumer so that the consumer knows how many times the opt-out feature has been used and how many opt-outs are left during a particular period of time.

Additional details of an illustrated demand response communicating thermostat 18 of the present disclosure include both consumer features and power provider features as follows.

### Consumer Features

### Basic Thermostat

Electronic thermostat controls heating, cooling and fan
Support for gas and electric heat and heat pumps, single or multi-stage
7-Day programmability with 4 timed heating and cooling changes per day
Temperature hold mode for temporary, permanent, and vacation time periods
On-screen menus
Celsius or Fahrenheit display
Password lock on user display

### Demand Response

Display-Control Event Notifications:
Countdown of the control event
Event completion
Return to normal

### Opt-Out

Consumer may cancel an event in progress or opt-out of events for one day

### Remote Access

Provides complete control of thermostat from a user password-protected web page
Monitor temperature and modify the daily program

### Power Provider Features

### Administration

Define control strategies for heating, cooling or both
Control event strategies for air handler cycling or temperature setback
Structure DR programs into groups to maximize power recovery and minimize consumer impact
Variety of 2-way communications media including mesh radio, cellular, ZigBee, BPL or other suitable 2-way radios

### Control Event Dispatch

Dispatcher selects groups of thermostats to participate in control event
Dispatcher selects control event strategies from pre-defined drop-down list

### Customer Support

Customer call center can have total access to thermostat to provide complete customer service
Consumer may sign up for a pay for performance participation level
Limit consumer override
Verify consumer participation when calculating reward levels

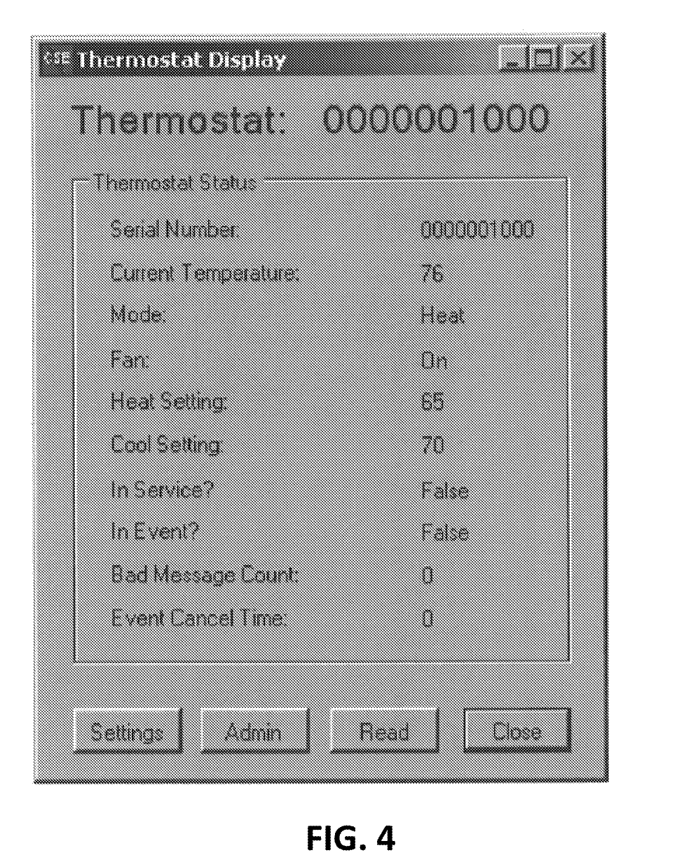

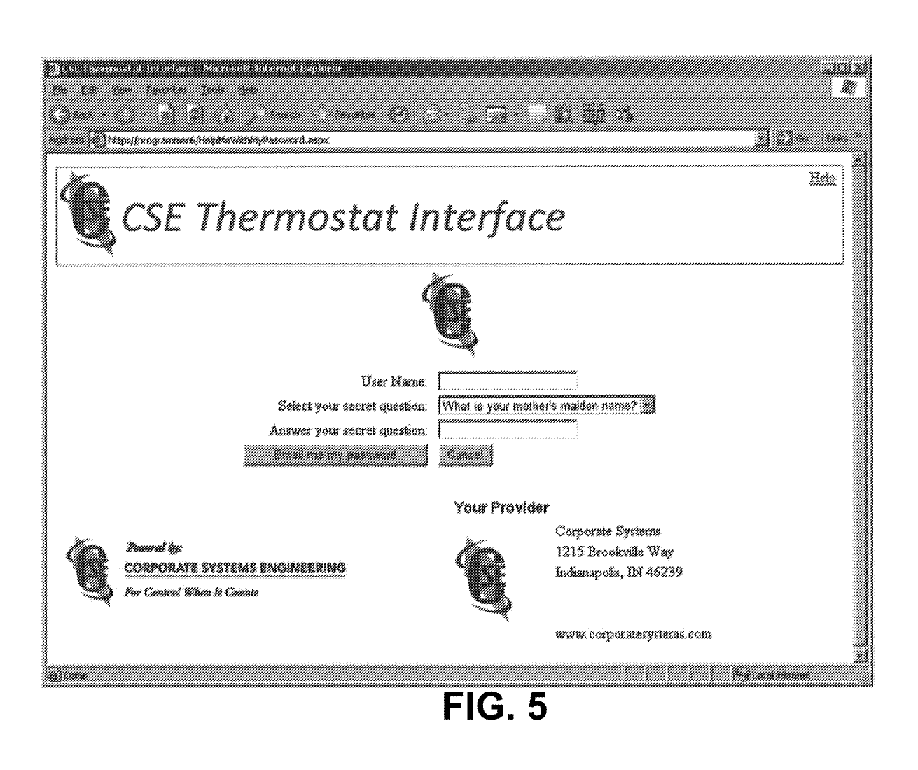

FIG. 4 is an example of a thermostat display on a monitor of an administrator's computer showing various settings and conditions for a particular thermostat 18 located at a consumer location. FIGS. 5-8 illustrate sample web pages or display screens to permit consumers to control the programmable thermostat 18 from remote locations through the graphical user interface 28 as discussed above. FIG. 5 shows an illustrative log-in screen for a thermostat interface.

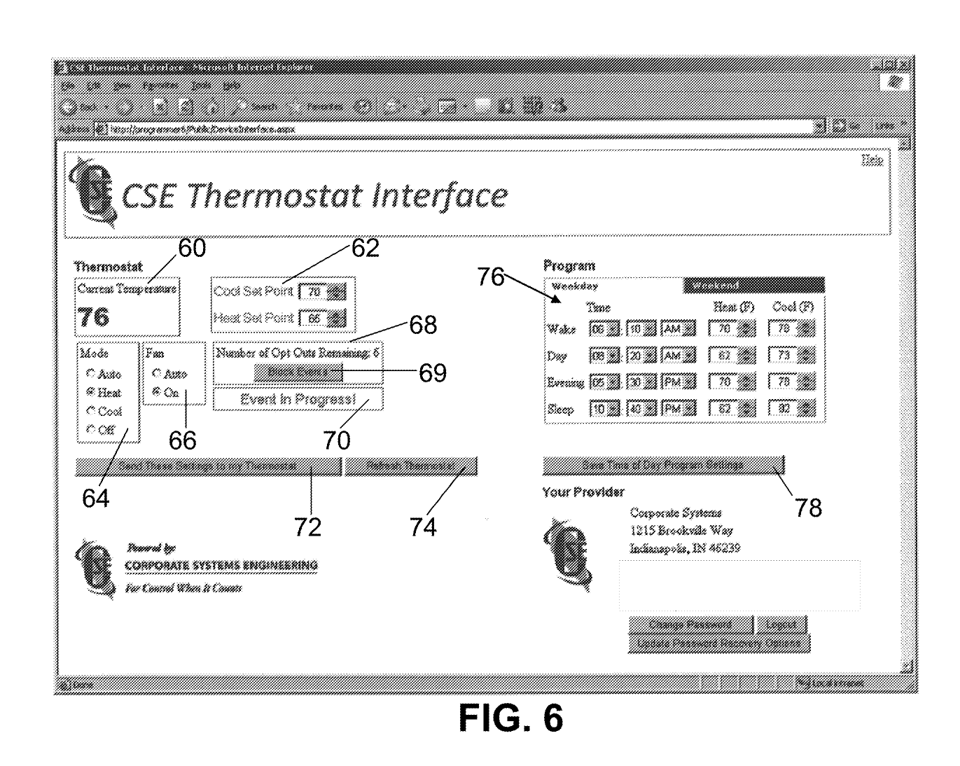

FIGS. 6-8 show various features of the thermostat interface. For instance, the current temperature is displayed at location 60, and the set points for heating and cooling are shown at 62. The “mode” settings are provided at 64, and the “fan” settings are provided at 66.

Block 68 shows an opt-out button 69 and the number of opt-outs remaining for a particular period of time. Block 70 shows that a current event is in progress. Showing the consumer that an event is in progress will explain why the current temperature is higher than the cool set point to the consumer. The fact that an event is in progress may also be shown on the programmable thermostat 18 at the consumer location. The interface also includes buttons for the user to click to send settings to the thermostat at block 72 and refresh the thermostat at block 74.

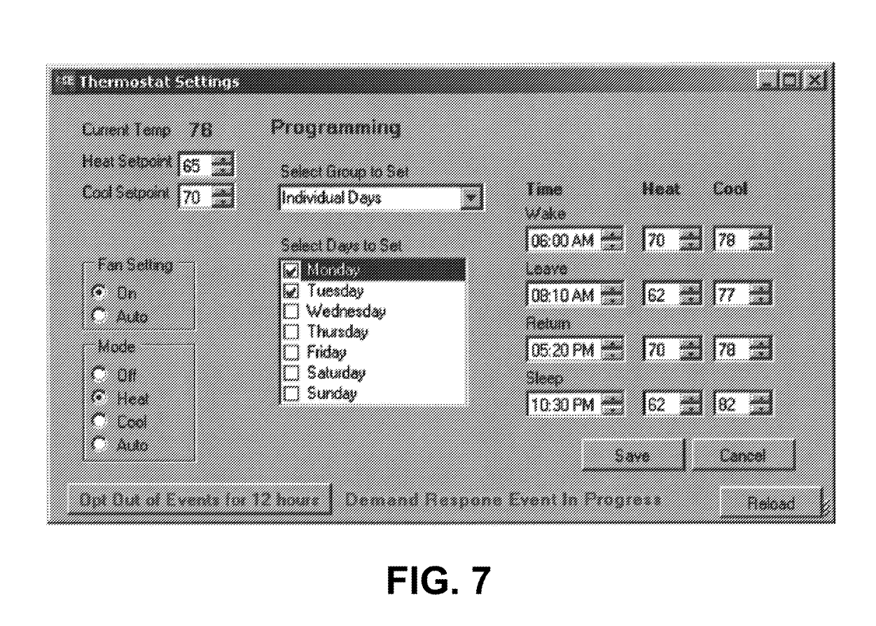

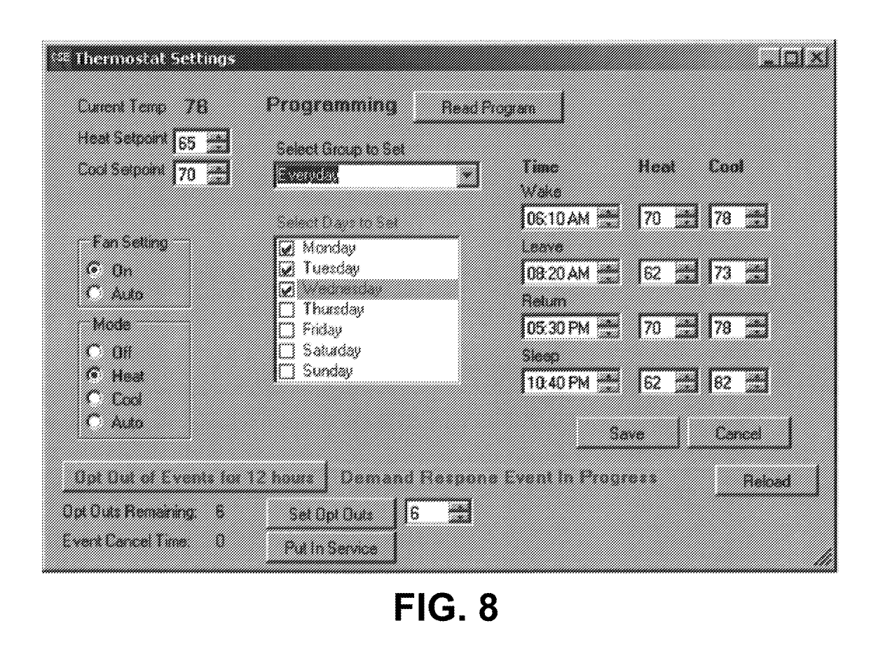

Thermostat interface further includes program settings 76 to program different times of the day with different heating and cooling set points. In the illustrated embodiment, four time periods are provided including wake-up time, day time, evening time, and sleep time. Program settings may be saved by clicking button 78. FIGS. 7 and 8 show different embodiments of display screens for thermostat settings. FIGS. 7 and 8 also show that a demand response event is in progress.

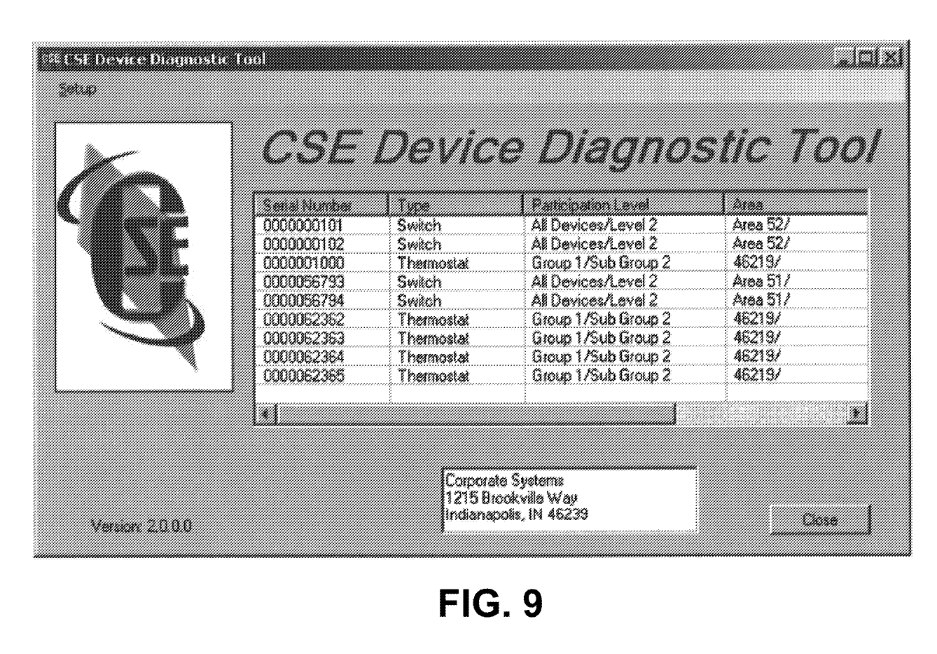

FIG. 9 illustrates a display screen for an administrative program diagnostic tool. An operator can select various devices to pull up information about the device. For instance, if the thermostat having serial number “0000001000” is selected, the status screen shown in FIG. 4 may be shown to the diagnostic user.

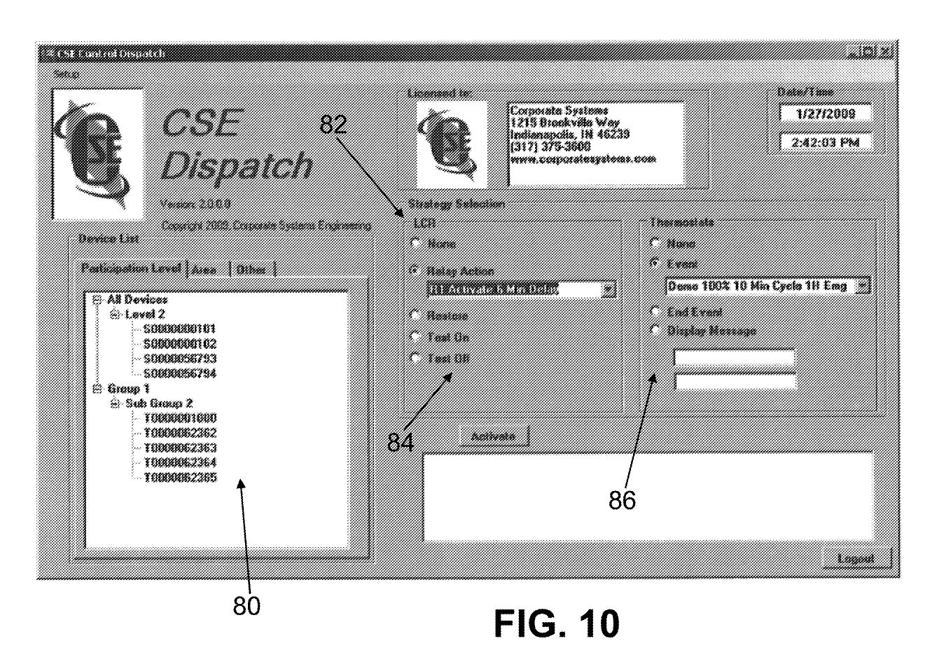

FIG. 10 illustrates a control interface screen for the dispatch program. The operator can sort through a device list as illustrated in area 80 of FIG. 10. FIG. 10 also illustrates a strategy selection section 82. An operator can control load control devices 16 as illustrated in section 84 or control thermostats 18 as illustrated in section 86. In section 86, the operator can set demand response “events” for the thermostats. When an event is requested as illustrated in FIG. 10, the main computer 32 sends signals to the appropriate thermostats 18 and load control devices 16 to start the event. In an illustrated embodiment of the present invention, a single event entry may provide both setback and cycling control of the thermostats 18. For instance, the controller may provide a temperature setback for the first period of time such as an hour and then provide cycling control of the thermostat 18 during a second hour of the event with a single control instruction.

FIG. 11 is a block diagram illustrating a load control device 16 for communicating with the demand response control system of FIG. 2. Main computer 32 communicates with the load control device 16 via two-way communication module 102 shown in FIG. 11. A microprocessor or other controller 104 of the load control device 16 is coupled to communication module 102. Microprocessor 104 is illustratively programmed with protocol logic such as ACP or DR two-way protocol control logic available from Corporate Systems Engineering. In addition, sensor monitoring device control logic and auxiliary device control logic are provided.

Illustratively, the microprocessor 104 of the load control device 16 accesses a memory to provide data storage capabilities. For example, the load control device 16 may include an auxiliary device SPI port. The microprocessor 104 may store data from a current transducer, data from a frequency counter, and line voltage data from an analog-to-digital converter. Microprocessor 104 may also store data in flash memory files. For example, the microprocessor 104 may store received commands, relay state changes and current status. In addition, the microprocessor may store information from the opt-out circuitry discussed below. For example, the microprocessor 104 may store the time and date that opt-out commands were entered, the number of remaining opt-outs for a particular time period, or other information related to the opt-out control.

As discussed below, optional opt-out logic may be provided for the load control device 16 in case the consumer chooses not to participate in a particular demand response event. The utilities can place parameters around the availability logic that will prevent or enable consumer opt-outs. Preferably, the opt-out parameters are viewable by the consumer. The controller 104 is configured to open and close relays 106, 108 in response to demand response controls from the main computer 32.

The load control device 16 of the illustrated embodiment provides demand response control over remote equipment. The device operates on various types of two-way communications as discussed herein. In addition, the load control device 16 monitors, records and transmits host voltage, amperage, and line frequency of a load at predetermined adjustable or customizable intervals. The load control device 16 may report this data on request. The load control device 16 provides remote auditing and load shed verification and reporting and is tamper evident.

Additional measurement and verification (M & V) features of the load control device 16 include: Verified Load Shed, Spinning Reserve, Remote Auditing, Certified Report Auditing, Tamper Evident, Certified Reporting, and Maintenance (Exception).

### M&V Control Device Functions

Demand Response Control over Remote Equipment
Operates on various types of one or two-way communications including: VHF/UHF, Cellular, BPL, Radio Mesh Networks including Landis+Gyr Gridstream (formerly UtiliNet)
Ability to record and transmit Host Voltage Amperage and Line Frequency of a load at predetermined customizable intervals and report that data on request
Remote auditing and load shed verification and reporting
Tamper evident

### Power Provider Functionality

Customizable control events from various shed/cycling strategies
Shed/Cycling strategies allow cycles from 6 minutes to 4 hours and off times from 6 minutes to 4 hours
Key Data Readings are calibrated to actual values
Contains internal and non-volatile data storage, which translates into a minimum of 30 days worth of key data (15 minute intervals)

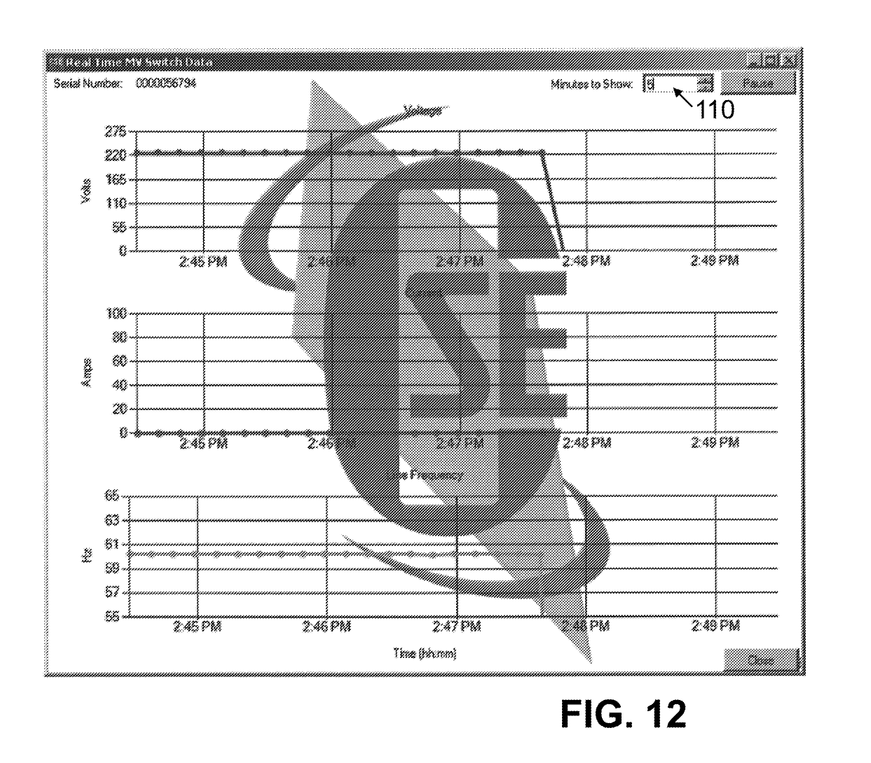

FIG. 12 is an illustrative graph of voltage, current, and frequency taken from an illustrated load control device 16. Illustratively, the usage output varies for each consumer. The line voltage typically varies by how close the device is to a feeder of the power supply. The frequency is generally constant for all residents handled by the same power supply, but may be an indicator of impending power failure. The amount of time shown in the graph can be adjusted with an input 110. In addition, the sampling rate for the data may be adjusted as desired. Data is sampled every 10 seconds in FIG. 12. However, data may be taken less frequently such as every 10-15 minutes, or even at longer intervals. In addition, data capture may be trigger by a percentage change in one of the values or when the load control device 16 is cycled on and off.

A direct load shed measurement may be obtained using these actual voltage and current values measured by the load control device 16. Therefore, the system does not require a separate meter in order to determine load shed. Providing the voltage, current and frequency outputs also permits load control device 16 to be used as an outage monitoring system. Upon detection of a power outage, the controller of the load control device 16 may be actuated to alert the utility of an outage before it is reported by the consumer.

In another embodiment of the present invention, the load control device 16 may be used to automatically shut off power to an appliance when the detected voltage supplied to the appliance drops below a predetermined threshold level. Supplied voltage is typically about 240 volts. If the supplied voltage drops below a predetermined amount, this may be an indication that a brownout is likely to occur in the near future. Therefore, the load control device 16 which already monitors the actually voltage supplied to the appliances may be activated to shut off power to the appliance when the supply voltage drops below a predetermined level to help reduce the likelihood of such brownouts.

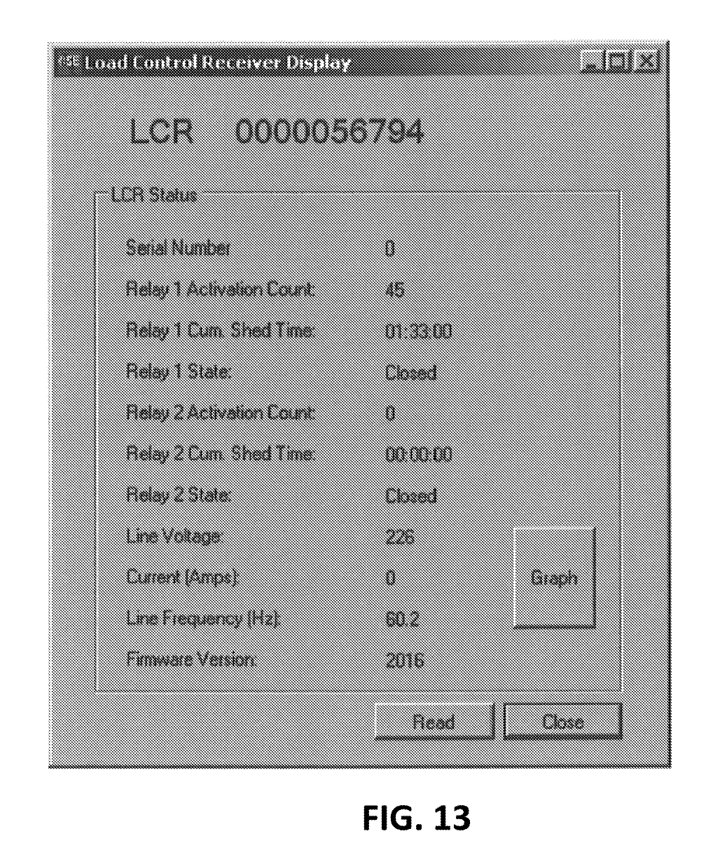

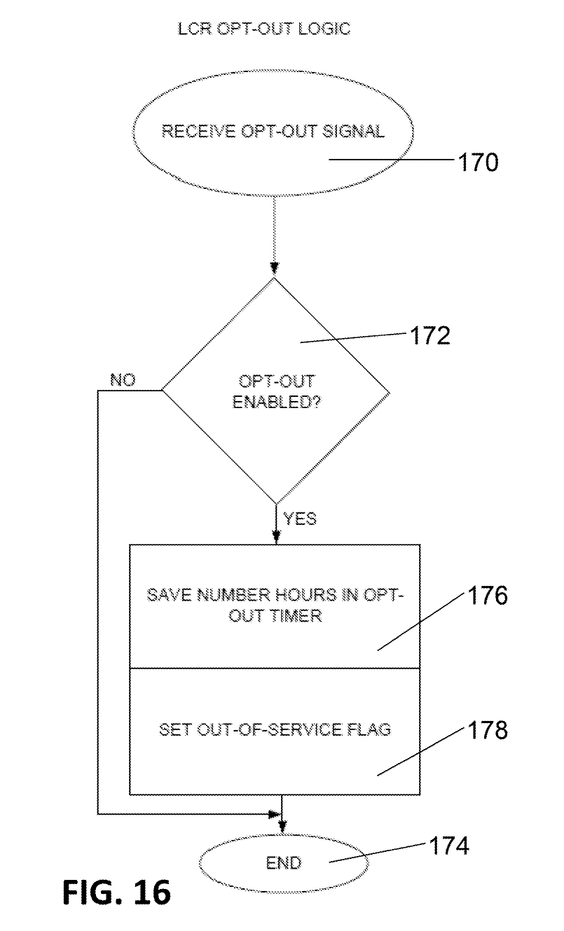

FIG. 13 is an illustrated display when a diagnostic user checks the status of a particular load control device 16 such as by using the diagnostic tool screen of FIG. 9 or other requests. As shown in FIG. 16, the line voltage, current and frequency for a particular load control device 16 are displayed.

As discussed above, the system of the present invention may include other sensors including indoor and outdoor temperature sensors. Therefore, the system of the present invention can factor in outside temperature into control algorithms. Factoring in such outside air temperature may be worthwhile for commercial demand response systems. In addition, when building a historical database for the utility, the database can factor in time and associated temperature to determine an anticipated load drop in response to an event. Utilities may make purchases based on such load estimates. If both the inside air temperature and outside air temperature are measured, the efficiency of a particular building or residence may be determined. Rebates to consumers may be based on an algorithm which takes into account the measured efficiency of the building. Use of outside temperatures can help validate that the amount of money saved was based on the load shed and not simply due to temperature variations.

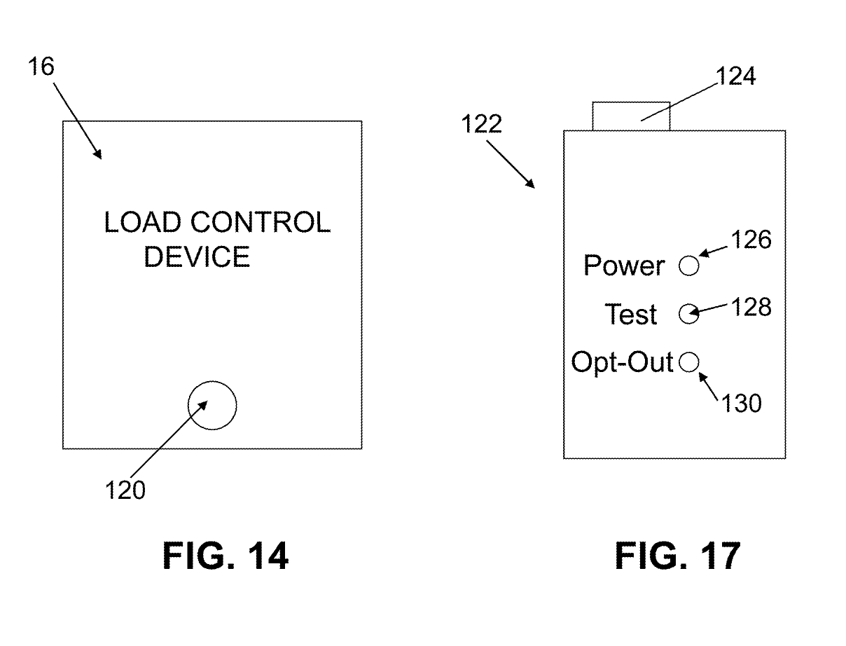

In one embodiment of the present invention, a load control device 16 includes an externally accessible push button control 120 which permits a consumer to opt-out of a particular demand response event as shown in FIG. 14. In other words, pressing button 120 will temporarily disable the load control device 16 and prevent the device 16 from shutting off the appliance, such as the air conditioner. Other types of opt-out input devices may be provided including a keypad or other input. In addition, a wireless detector such as an RFID tag or other suitable detector may be used to selectively opt-out from an event.

Typically, when the opt-out button 120 is pressed, the load control device 16 is prevented from shutting off the appliance due to a demand response event for a predetermined amount of time. In one embodiment, the predetermined amount of time may be twelve hours although any desired time period may be used. Again, the load control device 16 keeps track of the number of opt-outs that the consumer has used. The load control device 16 may record the date and time for each opt-out and send the information back to the utility's main computer 32 via two-way communications module 102 and communications path 14. The utility may send an alert if the consumer is about to exceed the monthly permitted allotment of opt-outs.

In another embodiment, the opt-out button 120 or other opt-out input switch discussed above may be used for diagnostic purposes. When a technician arrives to service the appliance such as an air conditioner, the technician can press the opt-out button 120 which starts the appliance running again regardless of whether or not a demand response event is in progress. In this embodiment, the diagnostic opt-out is for a lesser amount of time such as, for example, fifteen minutes. This permits the technician to run diagnostic tests on the appliance.

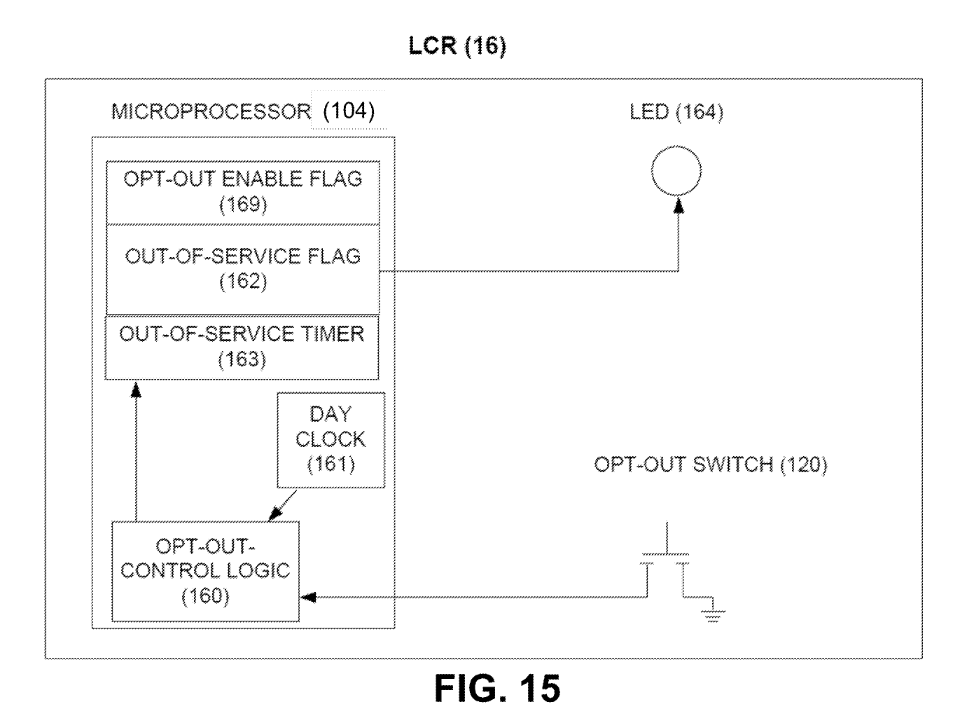

FIG. 15 is a block diagram illustrating details of the load control device 16 having opt-out control logic 160 for executing the opt-out function. In an illustrative embodiment, the load control device 16 includes a microprocessor 104 having associated memory. Opt-out control logic software 160 is stored in memory accessible by the microprocessor 104. A time and day clock 161 is accessible by the control logic 160. An opt-out enable flag 169, an out-of-service flag 162 and out-of-service timer 163 are provided. The opt-out enable flag 169 is typically set on the fly by a signal received from a utility's main computer 32. If the opt-out enable flag 169 is set, the load control device 16 may accept opt-out commands from the consumer. If the opt-out enable flag 169 is not set, the opt-out button 120 will not work to shut off power to the appliance and the load control device 16 will control the appliance based on the demand response events received without regard to the pressing of the opt-out control button 120.

FIG. 16 illustrates a flow chart of the steps performed by the opt-out control logic 160. When an opt-out signal is received in response to a user pressing the opt-out button 120 as illustrated at block 170, the microprocessor 104 first checks to determine whether the opt-out feature is enabled as illustrated at block 172. In the illustrated embodiment, the microprocessor 104 determines whether the opt-out enable flag 169 has been set by the utility at block 172. If not, the microprocessor advances to block 174 and ends without permitting the consumer to opt-out of a demand response event. If the opt-out is enabled at block 172, the microprocessor 104 stores the number of hours for the opt-out period in the opt-out timer 163 as illustrated at block 176. Microprocessor 104 then sets the out-of-service flag 162 as illustrated at block 178. As shown in FIG. 15, the status of the out-of-service flag 162 is shown on an LED 164. In one embodiment, the LED 164 is lit when the consumer has opted out of a particular demand response event and the out-of-service flag is set. In another embodiment, the LED 164 may be lit when the out-of-service flag is not set indicating that load control device 16 is in normal operation mode. Once the out-of-service timer 163 has expired, microprocessor 104 clears the out-of-service flag 162 so that the load control device 16 operates in normal mode in response to the next demand response event. The microprocessor 104 stores the time and date that the opt-out button was activated in a memory as discussed above.

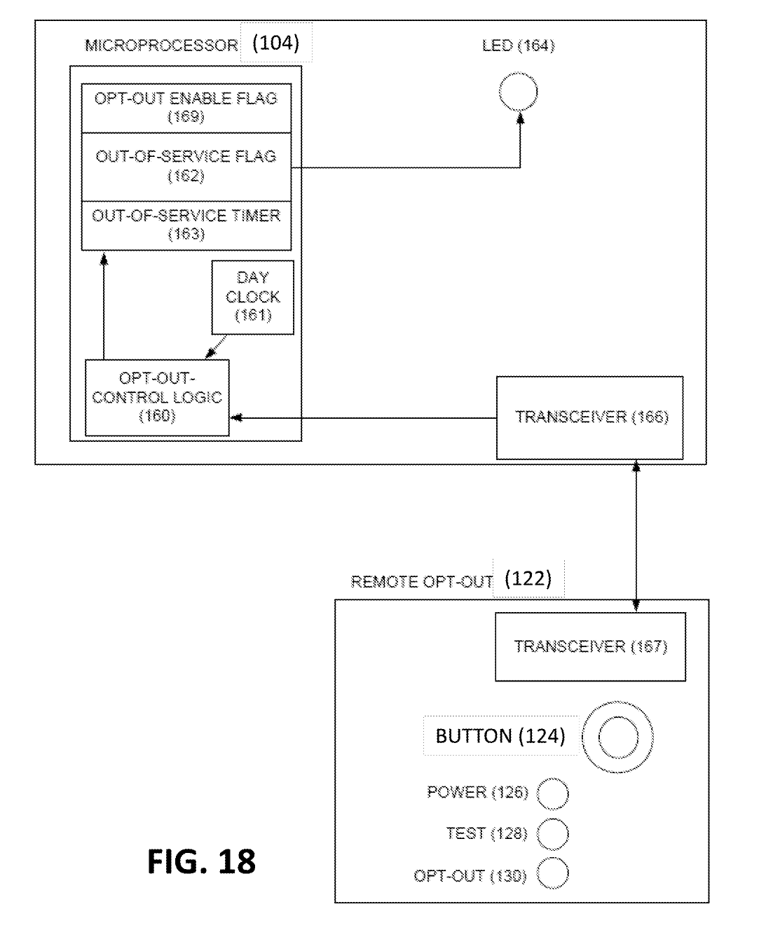

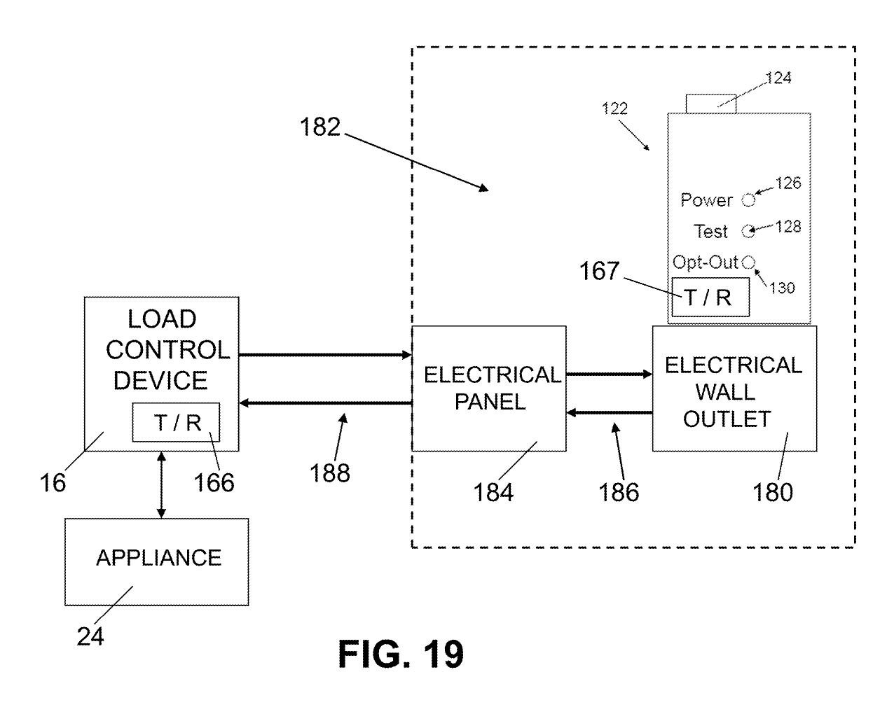

In another embodiment, a remote opt-out device 122 is provided in the house or building spaced apart from the load control device 16 which is typically outside next to the air conditioner. FIGS. 17-19 illustrate one embodiment of the remote opt-out device 122. A remote opt-out device 122 illustratively includes an opt-out button 124 accessible to a user. As discussed above, another type of user opt-out input may be used. In one illustrated embodiment, the opt-out device 122 illustratively plugs into an electrical outlet as shown in FIG. 17. Pressing the button 124 sends a signal through the power line (FIG. 19) or a wireless signal (FIG. 18) to the load control device 16 which performs the opt-out function as discussed above. The opt-out device 122 illustratively includes indicator lights to show that the device 122 is receiving power at location 126. Device 122 further includes a test light 128 and an opt-out light 130. When the opt-out light 130 is lit, this indicates that the user has opted out of a particular event. In addition, a LCD or other type of display may be provided on the opt-out device 122, if desired. A two-way communication remote opt-out button or a one-way communication remote opt-out device 122 may be used.

FIG. 18 illustrates the operation of the remote opt-out device 122 in one illustrated embodiment. The load control device 16 includes a transceiver 166 and a remote opt-out device 122 includes a transceiver 167. When the consumer presses the opt-out button 124, transceiver 167 sends a signal to transceiver 166 which passes the signal to the opt-out control logic 160. The load control device 16 then processes the opt-out signal as discussed above in connection with FIGS. 15 and 16. Transceivers 166 and 167 may communicate wirelessly or over the electrical lines in the house.

FIG. 19 shows the remote opt-out device 122 connected to an electrical wall outlet 180 located within a building 182. Wall outlet 180 is connected to electrical panel 184 via electrical lines 186. The electrical panel 184 is connected to load control device 16 via electrical lines 188. As discussed above, the transceiver 167 of remote opt-out device 122 communicates with transceiver 166 of load control device 16 wirelessly or by sending the signal over electrical lines 186, 188.

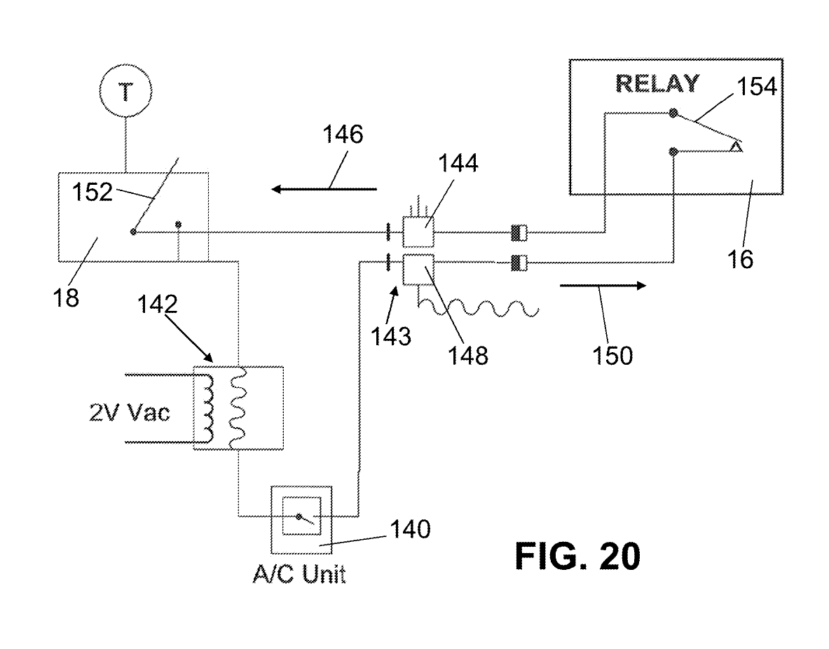

Another embodiment of the present invention is illustrated in FIG. 20. In this embodiment, both a thermostat 18 and a load control receiver 16 are used with an appliance such as air conditioning unit 140. As an attempt to thwart the effect of the load control receiver, some consumers have bypassed load control device 16 with a jumper wire eliminating the effect of the relay of the load control device 16. The embodiment disclosed in FIG. 20 detects such tampering. The first circuit 144 sends a signal in the direction of arrow 146 and a second circuit 148 sends a signal in the direction of arrow 150. If a signal from circuit 144 is received at circuit 148 then it is determined that a thermostat relay 152 was closed. If a signal sent from circuit 148 is received at circuit 144 then it is determined that relay 154 of load control device 16 was closed. Therefore, the system can tell if relays 152 and 154 at thermostat 18 and load control device 16 were open or closed. By monitoring the condition of relays 152 and 154 and comparing with the commands sent, it can be determined whether or not someone has wired around a particular load control device 16. In addition, the system can tell that when a load control device 16 cuts out that the thermostat 18 was actually calling for power indicating that load shed has occurred due to the load control device 16. A blocking choke filter may be used in circuit as illustrated in FIG. 21.

The disclosure of U.S. Provisional Patent Application Ser. No. 61/206,580, filed Feb. 2, 2009, is expressly incorporated by reference herein.

While this disclosure has been described as having exemplary designs and embodiments, the present invention may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains.

1. An electrical load control management system associated with an appliance, the system comprising:
a load control device configured to selectively reduce power supplied to the appliance in response to a demand response event; and
an externally accessible opt-out control associated with the load control device, the opt-out control being actuatable to permit a consumer to opt-out of a demand response event.

2. The system of claim 1, wherein the appliance is one of an air conditioning unit, a heater, a furnace, a refrigerator, a freezer, a water heater, a dishwasher, and a pool pump.

3. The system of claim 1, wherein the opt-out control is located on the load control device.

4. The system of claim 1, wherein the opt-out control is located on an opt-out device separate from the load control device.

5. The system of claim 4, wherein the load control device and the opt-out device each include a transceiver to permit communication between the opt-out device and the load control device.

6. The system of claim 5, wherein the transceiver of the load control device and the transceiver of the opt-out device communicate wirelessly.

7. The system of claim 5, wherein the transceiver of the load control device and the transceiver of the opt-out device communicate over an electrical power line of a building.

8. The system of claim 7, wherein the opt-out device is plugged into an electrical power outlet within the building.

9. The system of claim 5, wherein the transceiver of the load control device and the transceiver of the opt-out device provide two-way communication between the load control device and the opt-out device.

10. The system of claim 4, wherein the opt-out device includes a transmitter and the load control device includes a receiver configured to receive one way communication from the transmitter of the opt-out device.

11. The system of claim 1, wherein the opt-out control is a push button switch.

12. The system of claim 1, wherein actuated opt-out control disables the load control device to prevent the load control device from shutting off power to the appliance for a predetermined period of time.

13. The system of claim 12, wherein the predetermined period of time is at least twelve hours.

14. The system of claim 1, wherein the load control device is in communication with a utility's computer at a remote location, the load control device being configured to selectively enable and disable the opt-out control based on instructions received from the utility's computer.

15. The system of claim 1, wherein the load control device includes an indicator to provide an indication when the opt-out control has been actuated to opt-out of a particular demand response event.

16. The system of claim 1, wherein the load control device stores the number of times the opt-out control has been actuated and the number of remaining opt-out control uses available to the consumer for a particular billing period.

17. The system of claim 16, wherein the load control device sends data related to opt-out occurrences to a utility's computer at a remote location.

18. An electrical load control management system comprising:
a load control device configured to selectively reduce the power supplied to an appliance in response to a demand response event received from a utility's computer at a remote location, the load control device being configured to measure line voltage and current supplied to the appliance at predetermined time intervals, the load control device being configured to calculate power from the measured line voltage and current values before and after the demand response event to determine a direct load shed measurement corresponding to the demand response event.

19. The system of claim 18, wherein the load control device stores the measured line voltage and current taken at the predetermined time intervals in a memory of the load control device.

20. The system of claim 19, wherein the load control device transmits the stored line voltage and current values to a utility's computer located at a remote location.

21. The system of claim 18, wherein the load control device monitors the line voltage supplied to the appliance, the load control device being configured to automatically shut off power to the appliance if the monitored line voltage drops below a predetermined threshold level to reduce the likelihood of a brownout.

22. The system of claim 18, wherein the load control device detects a power outage by monitoring the line voltage and current, and the load control device being configured to transmit an indication of the power outage to a utility's computer located at a remote location.

23. The system of claim 18, wherein the load control device also measures a frequency of a signal supplied to the appliance.

24-33. (canceled)

34. An electrical load control management system associated with an appliance, the system comprising:
a load control device having a first relay, the load control device being coupled to the appliance and configured to selectively reduce power supplied to the appliance in response to a demand response event;
a thermostat coupled to the appliance, the thermostat having a second relay;
means located between the load control device and the thermostat for transmitting signals in opposite directions to monitor conditions of the first and second relays to determine whether the load control device has been wired around.

35. The system of claim 34, further comprising means for determining that when the load control device shuts off power to the appliance that the thermostat was calling for power to indicate that load shed occurred due to the load control device.

36. The system of claim 34, wherein a blocking choke filter is used to monitor conditions of the first and second relays.
